(19) United States
(12) Patent Application Publication
(10) Pub. No.: US 2026/0114964 A1
(43) Pub. Date: Apr. 30, 2026

(54) REMOVABLE SEAL FOR A DENTAL PROSTHESIS

(71) Applicant: Virginia M. Mitchell, Centereach, NY (US)

(72) Inventor: Virginia M. Mitchell, Centereach, NY (US)

(21) Appl. No.: 18/929,222

(22) Filed: Oct. 28, 2024

(51) Int. Cl. A61C 8/00

(52) U.S. Cl. CPC A61C 8/0068; A61C 8/0095

(57) ABSTRACT

Methods and apparatus for securing a dental restoration prosthesis such as a bridge or crown implant, to the jaw of a patient are provided. A dental implant is inserted into the jaw and is secured to the jawbone by osteointegration. An abutment is connected with the implant. The dental prosthesis is fitted over the abutment. A screw is inserted through an opening in the prosthesis that engages threads on the abutment to secure the prosthesis to the jaw. A cavity is formed proximal of the head of the screw below the proximal surface of the prosthesis. A flowable, two-part dental impression material is injected into the cavity. The impression material reacts to form an elastomeric plug that fills the cavity and excludes particles and liquids from the cavity. The elastomeric plug is removable from the cavity to expose the head of the screw to allow the prosthesis to be removed for adjustment or repair. Once the adjustment or repair is complete, the prosthesis is reconnected with the abutment by reinserting and tightening the screw. The elastomeric plug is inserted back into the cavity.

### BACKGROUND

### Field

The present disclosure generally relates to apparatus and methods for restoring lost, missing, damaged or diseased teeth. In particular, the disclosure relates to providing an elastomeric plug to occlude an opening on a dental prosthesis such as a bridge, single or multiple tooth implant, full mouth restoration and the like. The disclosure further relates to using a flowable material that is applied to an opening in such a prosthesis above the head of the prosthetic screw holding the prosthesis to the jaw that reacts to form an elastomeric plug to occlude the opening and where the elastomeric plug is removable to allow convenient access to the screw head.

### Description of the Related Art

Lost or missing teeth can be replaced by providing a patient with a dental prosthesis such as an implant crown, a bridge, or a full or partial fixed denture. These prostheses can replace one or more of a patient's teeth that are lost due to injury, disease, or as part of a cosmetic dental procedure.

Typically, a prosthesis is secured within a patient's mouth by installing an implant in the bony tissue of the mouth, i.e., the mandible and/or the maxilla. The bone is prepared by creating an opening in the bone. One or more implants are inserted into the bone. The implants include threads along its distal portion that are adapted to engage with the bone. Time is allowed for osteointegration where bone tissue grows onto the surface of the implant to create a secure connection to the bone.

According to one embodiment the prosthesis is connected to the implant indirectly by first connecting an abutment to the implant and then connecting the prosthesis with the abutment with a prosthetic screw. In the case of a multi-abutment prosthesis, multiple implants are fixed with the jawbone, the prosthesis is fitted over the abutments and secured to the abutments with screws.

According to another embodiment, where the prosthesis itself includes an abutment portion such as a screw-secured implant crown, the prosthesis is connected directly with the implant by an abutment screw. The implant crown is formed by a tooth-shaped crown that has a main body with a through-hole extending through the prosthesis and an abutment extending distally from the main body. An abutment screw is inserted along the through-hole and engages with internal threads on the implant. The screw is tightened and torqued to secure the implant crown with the implant in the patient's jaw.

Once the screw is inserted in the through-hole, the head of the screw is positioned distally of the surface of the prosthesis, creating a cavity proximal of the screw head and distal of the proximal surface of the prosthesis. This cavity allows the screw head to be recessed below the surface of the prosthesis. For example, where the prosthesis is a single or multiple tooth prosthesis, the head of the screw is recessed away from the biting surface of the tooth. The opening above the cavity allows a dental practitioner to access the screw head to turn the screw to tighten, loosen or remove the screw from the prosthesis. The practitioner may need to insert and remove the screw repeatedly while fitting the prosthesis to the patient's mouth to assure that the prosthesis performs properly and creates a comfortable bite. For example, the tooth may need to be reshaped in order to fit properly with adjacent and opposing teeth.

Once the practitioner is satisfied that the prosthesis is properly shaped and fitted, the practitioner secures the prosthesis with the implant by tightening the screw. At this point, the cavity above the screw head is open.

To occlude the cavity to prevent food particles and other materials from becoming lodged in the cavity, according to known methods, the practitioner fills the cavity with a temporary filling material, such as Tempit, manufactured by Centrix Inc. Shelton, Connecticut and the like. The temporary filling material is provided as a putty that is pressed into the cavity. This material hardens when it interacts with moisture, for example, water or saliva to form a solid, inelastic mass. This hardened material adheres securely with the inside surfaces of the cavity.

Once the temporary filling material is hardened to form a solid mass, the screw head cannot be accessed without removal of the solid mass. If the prosthesis needs to be removed, for example, to make further adjustments, to be replaced with a new prosthesis, or because the practitioner needs to treat tissue beneath the prosthesis, the hardened temporary filling material must be removed.

Removal of this hardened material may require a relatively lengthy procedure to drill out the hardened mass of filling material to allow access to the head of the screw. During this procedure, there is a risk that the head of the screw could be damaged, making it difficult for the practitioner to engage the screw. Also, removing the hardened filling material may damage surrounding portions of the prosthesis.

Thus, there is a need for apparatus and methods to occlude the cavity recessed within a prosthesis above the head of an abutment screw or prosthetic screw that can be easily installed and that can be removed without the risk of damaging the head of the screw or surrounding portions of the prosthesis.

### SUMMARY

The present disclosure provides methods and apparatus for installing dental prostheses, such as implant crowns, bridges, multi-unit abutment prostheses, full-mouth restorations, and the like where the cavity above the head of the prosthetic or abutment screw can be filled to prevent particles and liquids from entering the cavity. According to one embodiment, material for filling the cavity is provided as a two-part polymer system that is injected into the cavity as a flowable material or mixture, that fills the cavity to conform with the surfaces of the cavity and the head of the screw, that adheres to the surfaces of the cavity and that reacts to form an occlusive elastomeric plug. According to a further embodiment, the adhesive properties of the elastomeric plug allow the plug to be pulled from the cavity to expose the head of the screw without damage to the screw or to the dental prosthesis. According to a still further embodiment, the plug is formed from a two-part silicone formulation, where two components are mixed prior to being injected into the cavity, and where the components react to form a silicone plug with a selected hardness. According to a still further embodiment, the two-part formulation is a dental impression material.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is an exploded diagram showing a multi-abutment dental prosthesis being connected with the lower jaw of a patient according to an embodiment of the disclosure;

FIG. 2 is a cross section exploded diagram of a portion of the prosthesis of FIG. 1 showing the prosthesis being connected with the patient's jaw by an implant, an abutment, and a prosthetic screw;

FIG. 3A is a cross section showing the prosthesis of FIG. 1 where the screw and the abutment form a cavity above the head of the screw;

FIG. 3B shows the implant, abutment, screw, and prosthesis of FIG. 3A, where the cavity proximal of the screw head is overfilled with a flowable, two-part, impression material;

FIG. 3C shows the implant, abutment, screw, and prosthesis of FIG. 3B, where the impression material in the cavity is leveled with the proximal surface of the prosthesis;

FIG. 4 shows the implant, abutment, screw, and prosthesis of FIG. 3C, where the impression material reacted to form an elastomeric plug and where the plug is removed from the cavity to allow access to the screw head; and

FIGS. 5, 6, and 7 are cross section diagrams of a screw-retained implant abutment crown being connected with the jaw using an implant, an abutment, and an abutment screw according to a further embodiment of the disclosure.

### DETAILED DESCRIPTION

Exemplary embodiments of the disclosure will now be described below by reference to the attached Figures. The described exemplary embodiments are intended to assist the understanding of the invention and are not intended to limit the scope of the invention in any way. Like reference numerals refer to the elements throughout.

For the purposes of this disclosure, the terms “distal,” “distal of” and the like will be used throughout this disclosure to refer to the direction or relative position away from the practitioner performing a dental procedure and toward the body of a patient being treated. The terms “proximal,” “proximally,” “proximal of” and the like will be used throughout this disclosure to refer to the direction toward the practitioner and away from the body of the patient being treated.

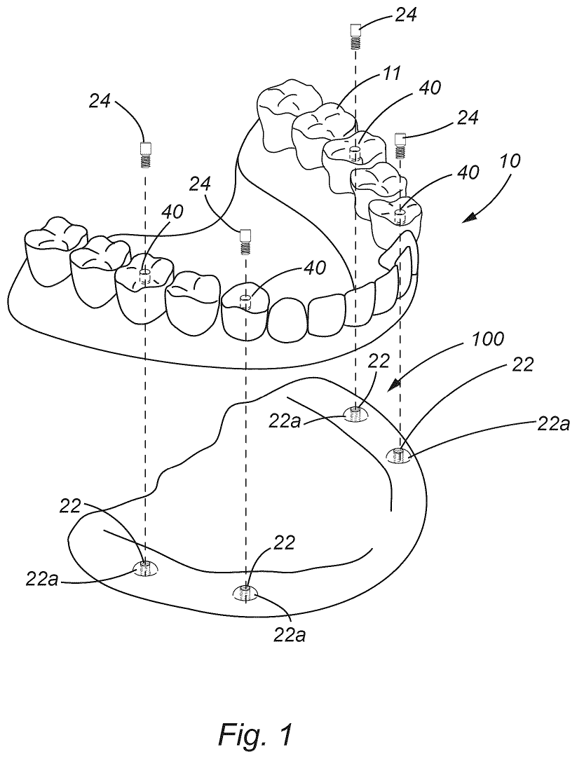

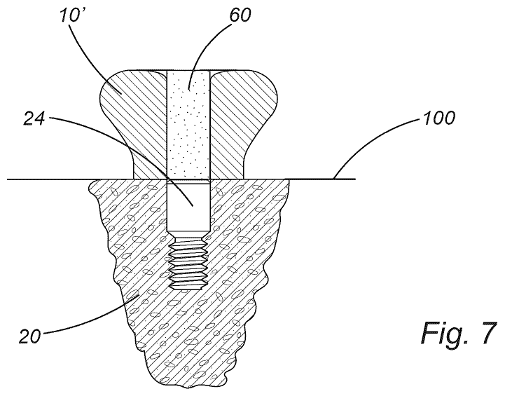

FIGS. 1-4 show methods and apparatus for connecting a dental prosthesis 10 for restoring multiple teeth 11, such as bridge or permanent denture, with the lower jaw 100 of a dental patient according to embodiments of the disclosure. FIGS. 5-7 show methods and apparatus for connecting a dental prosthesis 10′ for restoring a single tooth, such as a single tooth implant, with a patient's jaw 100 according to further embodiments of the disclosure.

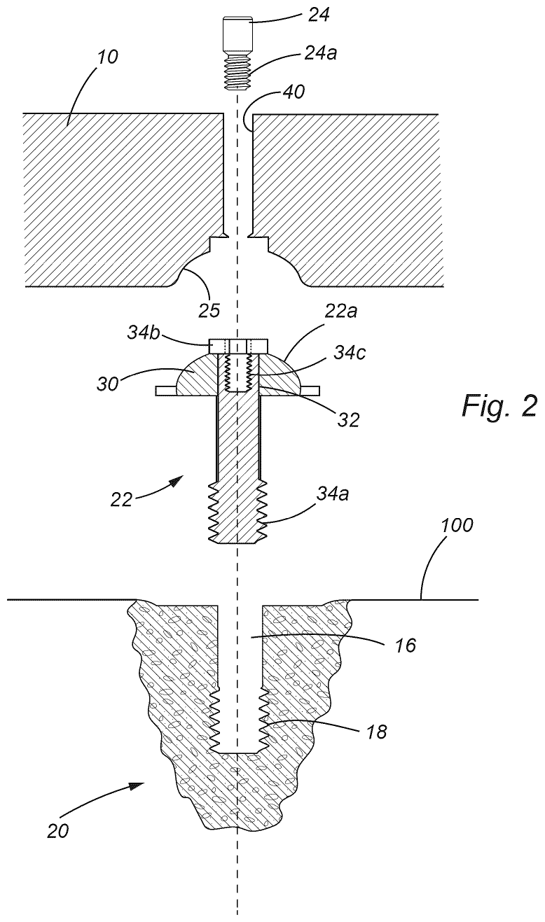

As shown in FIG. 1, the patient's jaw 100 has been prepared with a number of abutments 22 connected with the jaw 100. Prosthesis 10 has a respective number of openings 40 shaped to accommodate prosthetic screws 24. Each abutment 22 includes a convex engaging surface 22a that extends proximally upward from jaw 100. Prosthesis 10 includes concave engaging surfaces on the underside (not visible in FIG. 1) that are shaped to receive the convex engaging surfaces 22a in FIG. 2. Openings 40 extend through prosthesis and through the respective concave engaging surfaces 25. Abutments 22 are positioned on the jaw so that when prosthesis 10 is positioned against jaw 100 and the convex engaging surfaces 22a are fitted into the concave engaging surfaces 25 and the prosthesis is aligned with the patient's anatomy.

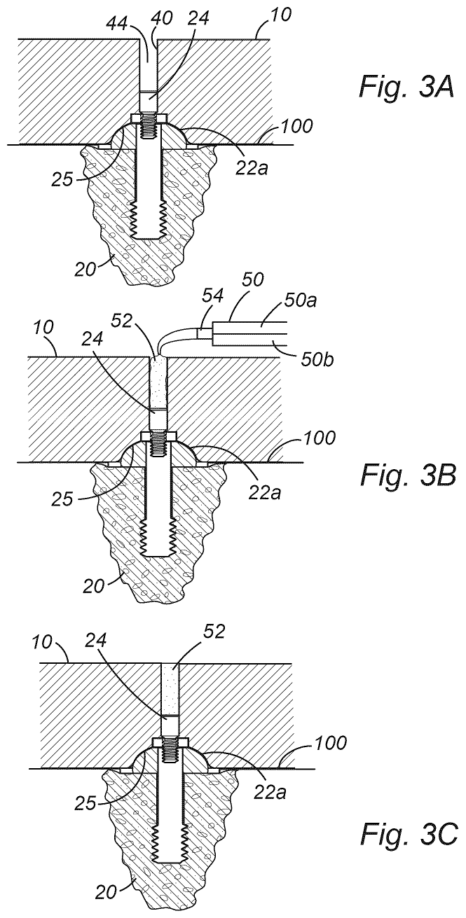

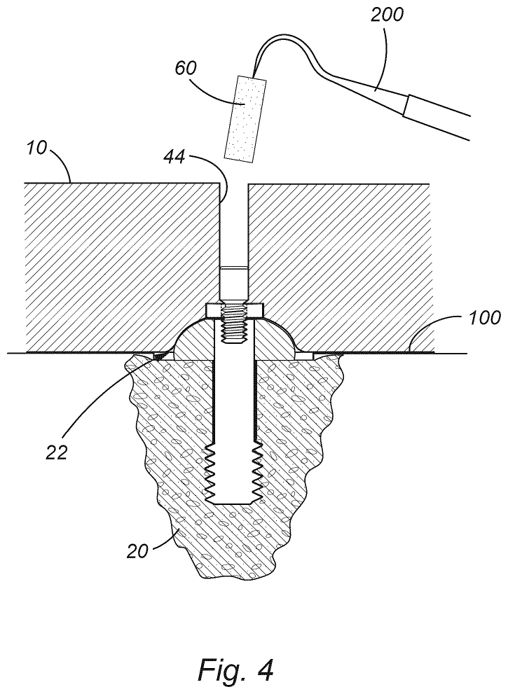

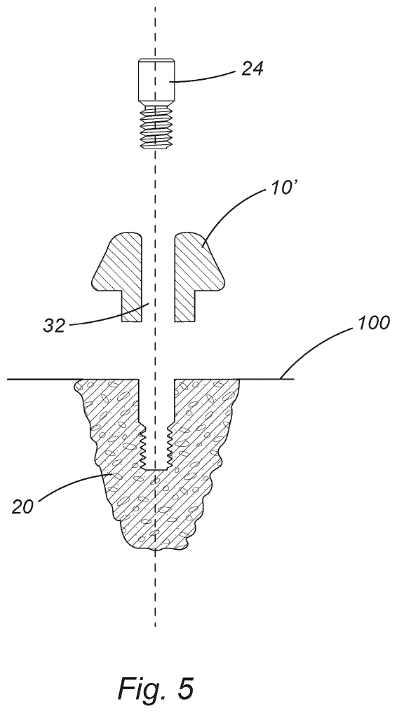

FIG. 2 shows a cross section of prosthesis 10 and the structures that secure prosthesis 10 to the jaw according to an embodiment of the disclosure. FIG. 3A shows prosthesis 10 connected with jaw 100. Prior to connecting prosthesis 10 with jaw 100, implant 20 is installed in jaw 100 according to methods known to those of skill in the field of the disclosure. According to one embodiment, one or more openings are drilled into the bone of jaw 100 and implants 20 are screwed into the bone. Bone tissue grows onto the surface of implant 20, forming a secure connection with the jaw.

According to one embodiment, multi-unit abutments 22 are connected with implants 20. As shown in FIG. 2, each abutment 22 has an internal passage 32 extending through the body. Abutment screw 34 extends through passage 32 with a threaded end 34a extending from body 30. According to one embodiment, screw 34 has a head 34b that can be rotated using a tool such as a hex driver. Implant 20 forms cavity 16 with female threads 18 at a lower end. Abutment 22 is shaped to fit into cavity 16. When implant 20 has been secured to jaw 100, the practitioner fits abutment 22 into cavity 16. The practitioner rotates screw 34, for example, by engaging head 34b with a hex driver (not shown), threads 34a engage with the threaded portion 18 of implant 20 to connect abutment 22 with the jaw.

According to one embodiment, a number of multi-unit abutments 22 are provided, as shown in FIG. 1 at locations and orientations determined by the practitioner. Prosthesis 10 is formed with the same number of concave engaging surfaces 25 that are each located and shaped to fit over convex engaging surfaces 22a that are connected with jaw 100.

As shown in FIG. 2, abutment 22 has internal screw threads 34c. Prosthetic screw 24 is fitted through hole 40 in prosthesis 10. Threads 24a of screw 24 engage with threads 34c of the multi-unit abutment 22. When screw 24 is fully threaded into multi-unit abutment 22, screw 24 pulls prosthesis 10 distally to secure prosthesis 10 with the jaw. The practitioner uses a tool, such as a hex driver (not shown), to rotate screw 24 to thread it into multi-unit abutment 22. FIG. 3A shows screw 24 pulling prosthesis 10 toward abutment 22. FIG. 3b shows prosthesis 10 fully engaged with abutment 22 so that convex engaging surface 22a is in contact with concave engaging surface 25.

A practitioner may need to adjust prosthesis 10, for example, by reshaping one or more prosthetic teeth 11, so that the anatomy of the prosthetic teeth matches the anatomy of the patient's mouth. To remove prosthesis 10, the practitioner uses the hex driver to remove screws 24 from each of the abutments 22. Once the practitioner is satisfied that the fit of the prosthesis is correct, the practitioner again secures prosthesis 10 to jaw 100 by tightening screw 24 into abutment 22.

According to one embodiment of the disclosure, the head of screw 24 is recessed below the proximal surface of prosthesis 10, leaving a cavity 44, as shown in FIG. 3A. According to one embodiment of the disclosure shown in FIG. 3B, a double cylinder syringe 50 containing a two-component silicone formulation is provided. Each component 50a, 50b is a flowable material. According to one embodiment, one component includes a catalyst and the other cylinder includes a base material that reacts with the catalyst. The practitioner delivers the materials to cavity 44 via a mixing tip 54 to form a mixture 52. When mixed, a chemical reaction, such as an addition reaction occurs, causing the components 50a, 50b to form an elastomer.

As shown in FIG. 3B, mixture 52 fills cavity 44. The viscosity of mixture 52 before the components have reacted may be selected so that the mixture readily flows throughout cavity 44 forming an occlusive seal between the mixture and sides of the cavity. According to one embodiment, as shown in FIG. 3B, cavity 44 may be overfilled so that mixture 52 extends somewhat proximally of the proximal surface of prosthesis 10.

As shown in FIG. 3C, according to one embodiment, the practitioner removes excess mixture 52 so that the proximal surface of mixture 52 is even with, or recessed below, the proximal surface of prosthesis 10. The components 50a, 50b react to form an elastomeric plug 60 filling cavity 44.

According to one embodiment, components 50a, 50b are selected to react to form plug 60 with a Shore A hardness between about 20 and 70, preferably about 41. According to one embodiment, components 50a, 50b react so that plug 60 is elastomeric. According to one embodiment, materials forming plug 60 include, but are not limited to addition and condensation silicones, polysiloxanes such as vinyl polysiloxane, and combinations thereof. According to a preferred embodiment, components 50a, 50b are a chemical system for preparing dental impressions. The use of dental impression material to form plug 60 may be advantageous because impression material can be provided using relatively low viscosity components that readily fill space within cavity 44, that react quickly to reduce the time required to install the prosthesis, are biocompatible, and that are dimensionally stable. According to a preferred embodiment, plug 60 is formed from an addition reaction silicone chemical system, for example, Splash!Max® Lite Body Impression Material, manufactured by Den-Mat Holdings, LLC of Lompoc, California.

Embodiments of the disclosure may use a two-component chemical system to form plug 60. According to other embodiments, a single component system may be used to form plug 60. For example, plug 60 may be formed from a single flowable precursor that is transformed into plug 60 by a hydration reaction when exposed to moisture, by an oxidation reaction when exposed to air, or by photopolymerization by being exposed to light energy at selected wavelengths.

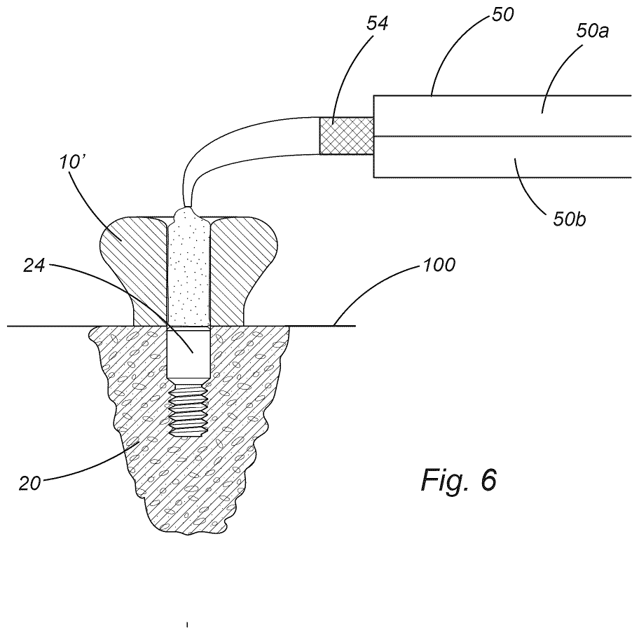

According to one embodiment, plug 60 adheres to the inside surfaces of cavity 44 so that the plug is secured to the prosthesis and will not fall out during normal use. Components 50a, 50b may be chosen so that the adhesion between plug 60 and cavity 44 is such that plug 60 can be grasped by an instrument 200 and pulled out from cavity 30a. FIG. 4 shows plug 60 being removed from cavity 44 with an instrument 200, such as a dental explorer, a scaler, a curette, or the like. This exposes the proximal surface of the head of screw 24, allowing the practitioner to engage the screw with a hex driver to remove it. The practitioner may remove plug 60 to treat the patient's tissue beneath prosthesis 10, or to make further adjustments to the prosthesis. The convenient removal of plug 60 allows such treatment without having to cut through hardened dental filling material used with known methods of installing dental prosthetics.

According to a further embodiment, components 50a, 50b of mixture 52 are chosen so that the dimensions of plug 60 are stable once the plug has been removed from cavity 44, as shown in FIG. 4. Because plug 60 retains its shape once it is pulled from cavity 44, the plug can be pressed back into cavity 44. This avoids the need to reapply a new mixture 52, which may reduce the time required for procedures where prosthesis 10 needs to be removed and then reattached. If plug 60 is damaged, either during use by the patient or when the plug is removed from cavity 44, as shown in FIG. 4, a new plug can be created by refilling cavity 44 with mixture 52 to form a new plug 60 according to embodiments discussed above.

FIGS. 5-7 show another embodiment of the disclosure. Screw-retained implant abutment crown 10′ is provided for restoring a single tooth. Crown 10′ includes through-hole 32. As with previous embodiments, implant 20 is installed into jaw 100 using techniques known to those of skill in the field of the disclosure. Screw 24 is inserted through hole 32 to engage with implant 20. As shown in FIG. 6, the head of screw 24 is recessed below the proximal surface of screw-retained implant abutment crown 10′ so that the head of the screw does not interfere with the biting surface of the implant crown.

As shown in FIG. 6, once the practitioner is satisfied that implant crown 10′ is properly shaped and fitted to the patient, screw 24 is tightened into implant 20, fixing the implant to the jaw. According to one embodiment, a two-component impression material 50a, 50b is provided from syringe 50. Mixing tip 54 is provided to assure proper mixing of components 50a, 50b. As shown in FIG. 7, components 50a, 50b react to form an elastomeric plug 60. Prior to these materials setting, the practitioner may remove excess material extending above the proximal surface of the implant so that the plug is even with or recessed below the proximal surface of crown 10′. As with previous embodiments, components 50a, 50b may be selected so that plug 60 can be removed from cavity 44 to expose the head of screw 24. Materials forming plug 60 may be selected to be dimensionally stable so that plug 60 can be replaced into cavity 44.

As shown throughout the drawings, reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A dental prosthesis assembly comprising:
a dental implant;
an abutment connected with the implant;
a screw having a distal threaded portion and a screw head at a proximal end;
a prosthetic body, wherein the body includes a through hole, wherein the screw is positioned in the through hole and extends distally from the prosthesis to engage the abutment, wherein a proximal portion of the through hole receives the screw head, and wherein the proximal portion of the through hole and the screw head define a cavity; and
a plug disposed within the cavity, wherein the plug fills the cavity to exclude particles from the cavity, wherein the plug is formed from an elastomeric material.

2. The assembly of claim 1, wherein the elastomeric material is formed by one or more flowable components introduced into the cavity, wherein the one or more components react to form the elastomeric plug.

3. The assembly of claim 2, wherein the flowable components are a two-part system.

4. The assembly of claim 3, wherein the two-part system comprises an addition reaction silicone formula.

5. The assembly of claim 1, wherein the plug has a hardness between about 20 and about 70.

6. The assembly of claim 1, wherein the plug is removable from the cavity intact.

7. The assembly of claim 6, wherein, after the plug is removed intact from the cavity, the plug is adapted to refit into the cavity to fill the cavity and exclude particles from the cavity.

8. The assembly of claim 1, wherein the prosthetic body is a single or multiple tooth implant crown, a bridge, a partial or complete fixed denture or a full mouth restoration device.

9. A method for installing a dental prosthesis comprising the steps of:
connecting an implant assembly with a bony structure;
fitting a prosthetic body to the implant assembly wherein the prosthetic body includes a through hole extending through the body from a proximal surface to a distal surface of the body;
inserting a screw through the through hole, the screw having a screw head at a proximal end thereof;
engaging the screw with the implant assembly to secure the prosthetic body with the bony structure, wherein a proximal portion of the through hole and the head of the screw define a cavity;
depositing one or more flowable components into the cavity to form a mixture; and
reacting the one or more components of the mixture to form an elastomeric plug, wherein the plug conforms to an inner shape of the cavity.

10. The method of claim 9, wherein the step of depositing further comprises overfilling the cavity with the mixture and, following the step of depositing, removing a portion of the mixture, wherein a proximal surface of the mixture is even with or recessed below the proximal surface of the prosthetic body.

11. The method of claim 9, further comprising grasping the plug and pulling the plug from the cavity, wherein the plug is removed intact from the cavity.

12. The method of claim 11, further comprising replacing the plug into the cavity, wherein upon replacement the plug conforms to the inner surface of the cavity.

13. The method of claim 9, wherein the one or more flowable components are a two-part system.

14. The method of claim 13, wherein the two-part system comprises an addition reaction silicone formula.

15. A method of claim 14, wherein the elastomeric plug has a hardness between about 20 and about 70.
